(19) United States
(12) Patent Application Publication
(10) Pub. No.: US 2006/0195494 A1
(43) Pub. Date: Aug. 31, 2006

(54) Compiler, system and method for defining, assigning, executing and monitoring processes and tasks in process management applications

(75) Inventor: Robert W. Dietrich, Wilsonville, OR (US)

Correspondence Address: IDEA ADVOCATES LAW GROUP PC, 239 NW 13TH AVE., SUITE 310, PORTLAND, OR, 97209, US

(73) Assignee: Process Path, Inc.

(21) Appl. No.: 11/351,798

(22) Filed: Feb. 9, 2006

Related U.S. Application Data
(60) Provisional application No. 60/651,732, filed on Feb. 9, 2005.

(51) Int. Cl. G06F 15/02

(52) U.S. Cl. 708/110

(57) ABSTRACT

The invented software system and method is an easy-to-use, browser-based solution, providing casual business computer users the ability to create, modify, and monitor business processes, much like spreadsheet software allows users to quickly complete complex math calculations. It is built on a “fill in the table” interface so any user can create a customized process within minutes, without having to understand how to flow chart or program a computer. Automatic alerts regarding work to be done, sent through a normal email client, are included as part of the product's feature set as well as a chronological history and a variety of default reports. Processes are easy to set up, deploy, and control, and participation in those processes is simple and fast. Any process can be immediately launched and is saved as a template for later use or modification. Templates can be shared or sold to other users, as well. Briefly, the invented system and method includes software running on a server accessible via a network, e.g. a local area network (LAN) or wide area network (WAN) such as the world-wide web by subscribing and logged on one or more proximate (centralized) or remote (distributed) users with laptops, desktops or workstations. The software features a friendly user interface with toolboxes, menus and buttons for patterned templating of processes and tasks and for management and oversight of the same. Process authors can construct templated processes in a table-drive manner that is parse-able by a process compiler and executable by a process engine. Process users can create task assignees chosen at will or from their own address books. Task assignees can use the software to follow optionally check-listed task steps and start/stop dates and times can be monitored and logged. Finally, reports can be generated. E-mail is the preferred conveyance of task-notification messages among various users of the invented software.

### RELATED APPLICATIONS

The present application claims priority to U.S. Provisional Patent Application Ser. No. 60/651,732, entitled METHOD AND SYSTEM FOR DEFINING, ASSIGNING, EXECUTING AND MONITORING PROCESSES AND TASKS IN PROJECT MANAGEMENT APPLICATIONS and filed 9 Feb. 2005, the disclosure of which is incorporated herein in its entirety by this reference.

### BACKGROUND OF THE INVENTION

Companies collectively spend millions of people-hours every day manually tracking simple to complex people-intensive business processes, such as contract development, benefits enrollment, salary and wage processing, ISO 9000 and Sarbanes-Oxley Act documentation, travel requests, and expense reports. Automating these repetitive, repeatable activities increases a company's productivity while saving money, ensuring legal compliance and minimizing risk.

Large companies are automating these people intensive business processes and are realizing benefits today. Business Process Management (BPM), a new generation of software, is addressing this need for Fortune 1000 companies. BPM allows rapid development and deployment of people intensive processes by radically simplifying the typical programming cycle. This market is currently well served with “industrial strength” enterprise-focused Business Process Management solutions. These solutions require extensive IT expertise and strong corporate commitment over a multi-year project plus dedication to future maintenance.

However, medium-sized and small-sized organizations—including departments within large organizations—find it too difficult and costly to justify the automation and maintenance costs of enterprise software solutions. The need to streamline business processes is clearly a recognized issue, but affordable and useable Business Process Management solutions for these organizations are simply not available.

### SUMMARY OF THE INVENTION

Process Path™ software is an easy-to-use, browser-based solution, providing casual business computer users the ability to create, modify, and monitor business processes, much like spreadsheet software allows users to quickly complete complex math calculations. It is built on a “fill in the table” interface so any user can create a customized process within minutes, without having to understand how to flow chart or program a computer. Automatic alerts regarding work to be done, sent through a normal email client, are included as part of the product's feature set as well as a chronological history and a variety of default reports. Processes are easy to set up, deploy, and control, and participation in those processes is simple and fast. Any process can be immediately launched and is saved as a template for later use or modification. Templates can be shared or sold to other users, as well.

Briefly, the invented Process Path™ system and method includes Process Path™ software running on a server accessible via a network, e.g. a local area network (LAN) or wide area network (WAN) such as the world-wide web by subscribing and logged on one or more proximate (centralized) or remote (distributed) users with laptops, desktops or workstations. The software features a friendly user interface with toolboxes, menus and buttons for patterned templating of processes and tasks and for management and oversight of the same. Process authors can construct templated processes in a table-driven manner that is parse-able by a process compiler and executable by a process engine. Process users can create task assignees chosen at will or from their own address books. Task assignees can use the software to follow optionally check-listed task steps and start/stop dates and times can be monitored and logged. Finally, reports can be generated. E-mail is the preferred conveyance of task-notification messages among various users of the Process Path™ software.

Process Path™ is a trademark owned by Process Path, Inc. of Wilsonville, Oreg. 97070.

### BRIEF DESCRIPTION OF THE DRAWINGS

FIG. 1 is a system/network block diagram illustrating the hardware/software used to run the invented Process Path™ software in accordance with one embodiment of the invention.

FIG. 2 is a block diagram illustrating the process and task definition and monitoring system in accordance with one embodiment of the invention.

FIG. 3 is a block diagram illustrating the main process blocks in accordance with one embodiment of the invention.

FIG. 4 is a block diagram illustrating the main process templates in accordance with one embodiment of the invention.

FIG. 5 is a block diagram of a process compiler block shown in FIG. 2.

FIG. 6 is block diagram illustrating the main processes, reports and forms organization in accordance with one embodiment of the invention.

FIG. 7 is a block diagram illustrating the library components in accordance with one embodiment of the invention.

FIGS. 8A-8J are schematic diagrams representing system screen grabs of the user interface during various phases of the use of the invented process and task definition and monitoring system in accordance with one embodiment of the invention.

FIG. 9 is a flowchart illustrating the invented method in accordance with one embodiment of the invention.

### DETAILED DESCRIPTION OF THE PREFERRED EMBODIMENTS

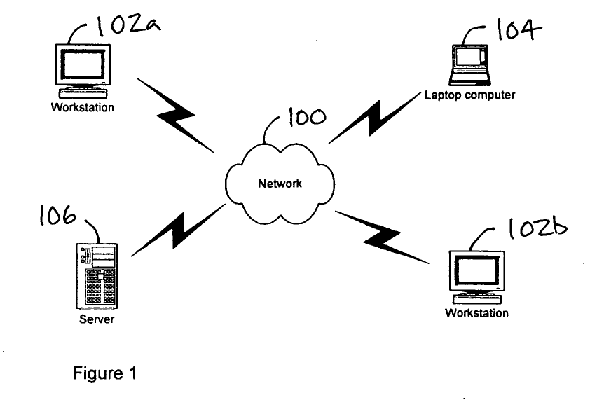

The invented system and method in accordance with one embodiment can be described as follows, by reference to FIGS. 1-9.

FIG. 1: System/Network Diagram is a system/network diagram illustrating the Network 100, one or more Workstations 102a, 102b and/or a desktop or laptop computer 104, and one or more servers, e.g. Server 106, on which the Process Path™ software executes in service of one or more users at least two of whom may be geographically distributed. Those of skill in the art will appreciate that the invented software resides in memory associated with a server and is executed by a processor that forms a part of the server. Thus, in brief summary, the invention involves a software solution to defining and monitoring processes and tasks, thereby assisting an organization that may involve distributed personnel in process management. Those of skill in the art will appreciate that, in accordance with one embodiment of the invention, the software solution is browser-based and the software is hosted by a Server. Nevertheless, within the spirit and scope of the invention, the software may be distributed over the Network and may execute instead on one or more Workstations. Network, of course, applies broadly to local area networks (LANs) or wide area networks (WANs) such as the world-wide web, i.e. the Internet.

The following definitions apply to the detailed description of the invention, for clarity in illustration purposes, and not by way of limitation of the invention.
1. A user is a person interacting with the system.
2. A user account collects various pieces of information associated with a user, including name, billing information, account type (free, template author, manager), address book, access rights, etc. A user account is referenced by the person's email address (e.g., george@somewhere.biz). A user must have a user account to interact with the system.
3. A process is a collection of one or more steps to accomplish a user-defined goal.

The steps may be sequential, repeated, or operate in parallel. Each step may be executed by a different user or by an automated process. Steps may involve a decision by the user. A process is started using a process template.
4. Each step of a process is called a task. Each task is delegated to a specific user or a group of users. If delegated to a group, then a member of the group must accept ownership of the task. A task typical gathers input from a person in order to complete that task, or else displays information gathered in a previous task. A task may allow the user to make a decision within the process. Completion of the task is specified by the user to which it has been delegated.
5. A process template defines the structure and sequencing of a process, especially the tasks that will be executed during the process. A process is started by selecting a process template and initiating the process. Process initiation specifies which user will “own” the process, and (directly or indirectly) which users will execute the tasks of the process.
6. A role serves as a placeholder in a process template for a user or group of users who will interact with a process based on that template. Examples of roles could be Manager, Payroll Clerk, or Reviewer. Roles eliminate the need to change a process due to changes in responsibility or personnel. The author of a process template defines the roles that will be used for the process. The assignment of users to specific roles is done statically by the template author or dynamically either by the initiator (owner) of the process, a task owner, or by the Process Path process engine.
7. An address book is a user attribute that contains symbolic mappings of group names to other group names or to individual user names. The address book can be used to facilitate the assignment of roles to users or groups of users when a process template is instantiated as a process. The address book is also used in enforcing security.
8. A field of a task represents data that are either being gathered or presented to a user. These data may come from internal or external data storage, another task, or may be embedded within the task itself (such as instructions for completing the task).
9. A form, much like a paper form, is used to format and display task fields to the user. The form specifies the structure of the presentation, and may be defined by the author of the task or automatically generated. A form presents the fields of the task to the user, either for input or for display.
   Components

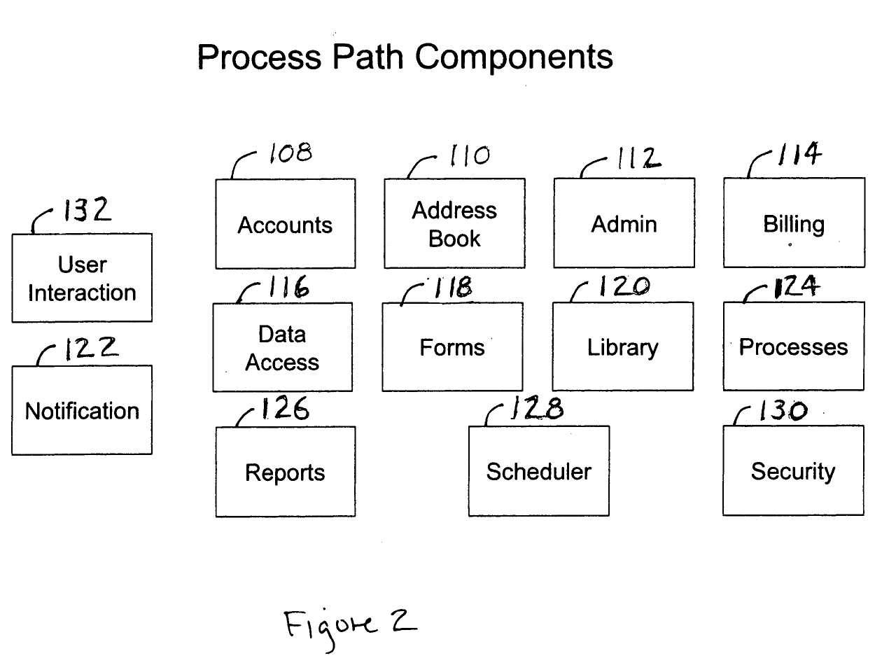

The Process Path™ software, in accordance with one embodiment of the invention, includes of the following components (see FIG. 2: Process Path Components):
Accounts (108)—maintains information about user accounts for each user of the system, including account type, name, address, etc.
Address Book (110)—for each user, maintains a private list of name, address pairs. Each address is a list of user accounts (email addresses), the first and last name of the person associated with a user account, or the name of another address book entry. Entries are used to fill in roles when a process is started and to control sharing through the Security component.
Admin (112)—provides administrative control and oversight of the system, including deleting user accounts, changing access rights, viewing system status, etc.
Billing (114)—handles payment and credit activities associated with user accounts.
Data Access (116)—in conjunction with the Security component, provides a uniform mechanism for accessing data, whether they are stored in an internal or external data store. This mechanism is used for both retrieving and storing process and report data.
Forms (118)—performs the formatting and layout of process and report data for viewing and data collection. Forms are automatically generated or can be created from document files (word processor, spreadsheet, etc.).
Library (120)—collects process and report templates for easy management in conjunction with the Security component. By default, no information is shared between user accounts. A user may decide to explicitly share templates to selected users. A user may also decide to publish templates in the public marketplace, either for free or for purchase.
Notification (122)—handles system and user-initiated contact of users, for instance, through email, instant messaging, or another mechanism. A user may click on the name of another user to send a question, or the system may notify a user that the user has a new task to perform.
Processes (124)—manages the construction and update of process templates, and execution of processes using process templates. The display or retrieval of data during a process step (task) is done through a form, whether automatically generated or provided by the author of the process template.
Reports (126)—provides retrieval of data gathered by the system, including history of process and task execution, as well as data gathered by processes. The display of data is done through a form, either automatically generated or provided by the author of the report template.
Scheduler (128)—handles time-based events in the system, such as notifying a task owner that the task is overdue.
Security (130)—controls access to data and templates in the system. Since information is not shared by default, the user must explicitly allow access to other users.
User Interaction (132)—supplies the user interface to the system, through a web browser, cell phone, personal information manager (PIM), personal digital assistant (PDA), email, voice, instant messaging, etc.
   Processes

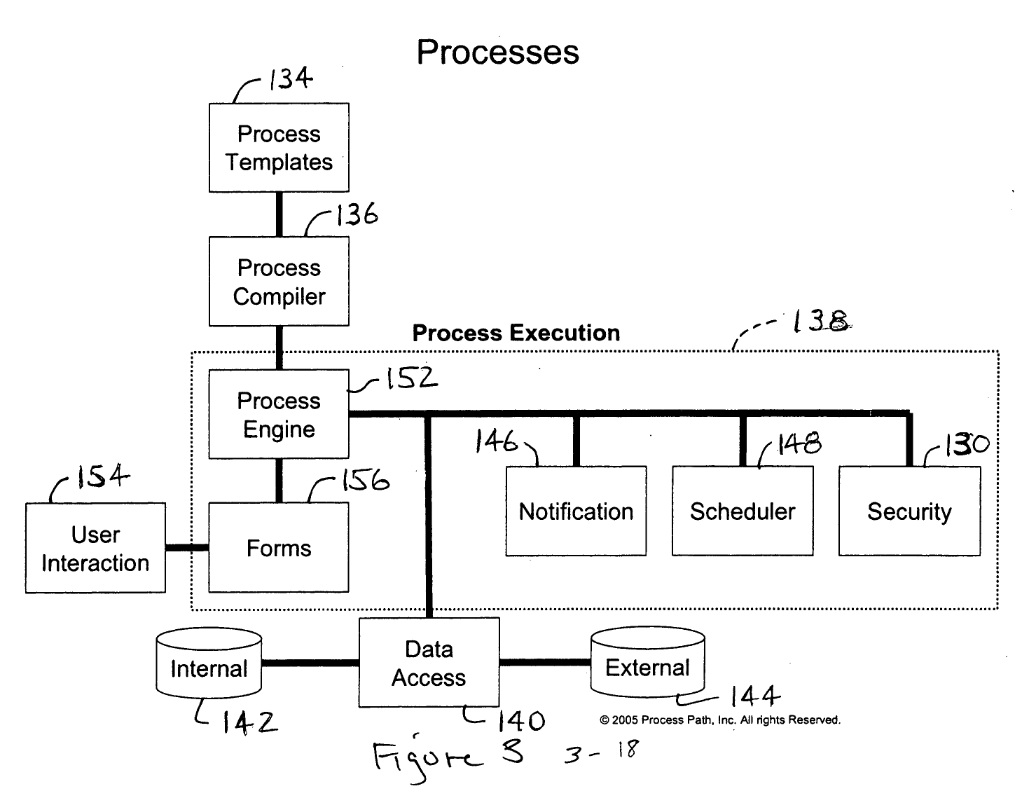

The Processes component (see FIG. 3: Processes) supplies the core functionality of the Process Path™ software. The component manages creation and update of process templates 134, preparation (compilation via process compiler 136) of the templates for execution, and the execution of a process (138) using the compiled process template.

The Process Path™ software maintains process templates in internal structures that closely support the unique features offered by the system, including such features as automatic detection (e.g. via the use of the calendar and scheduler functions of the software) of a task the completion of which has been delayed beyond the limit set by the process template's author and automatic escalation. Automatic escalation occurs, for instance, when the automatic detection software detects that a task has failed to complete within a limited amount of time designated by the template's author. These structures make the system simple and easy to use when creating or modifying process templates. However, these structures do not represent the most efficient form for process execution. The Process Compiler component 136 is responsible for translating the process template structures into a different form for execution.

Several components interact with the Process Execution component 138 while a process is executed. The Data Access component 140 provides consistent access to data, whether stored in an internal data store 142 or an external data store 144 provided by the user. The Notification component 146 notifies task owners via e-mail when they are assigned a task. The Scheduler and Security components 148 and 130 are responsible for scheduled execution of tasks in accordance with defined security parameters as well as notifying task owners when they have not completed a task on time, e.g. via an e-mail that effectively automatically escalates the overdue task completion. At the heart of the Process Execution component 138, of course, is Process Engine 152 itself, which actually executes the compiled process.

The Process Execution component 138 also interacts with the user through the User Interaction and Forms components 154 and 156. As each task of a process is executed, data are gathered or displayed through a Forms component 156 presented through the User Interaction component 154.

Process Templates

Process Templates define the structure and sequencing that will be used to execute a process. Process Templates are much like an empty crossword puzzle; they both define the format and rules for the data (words) entered by the user.

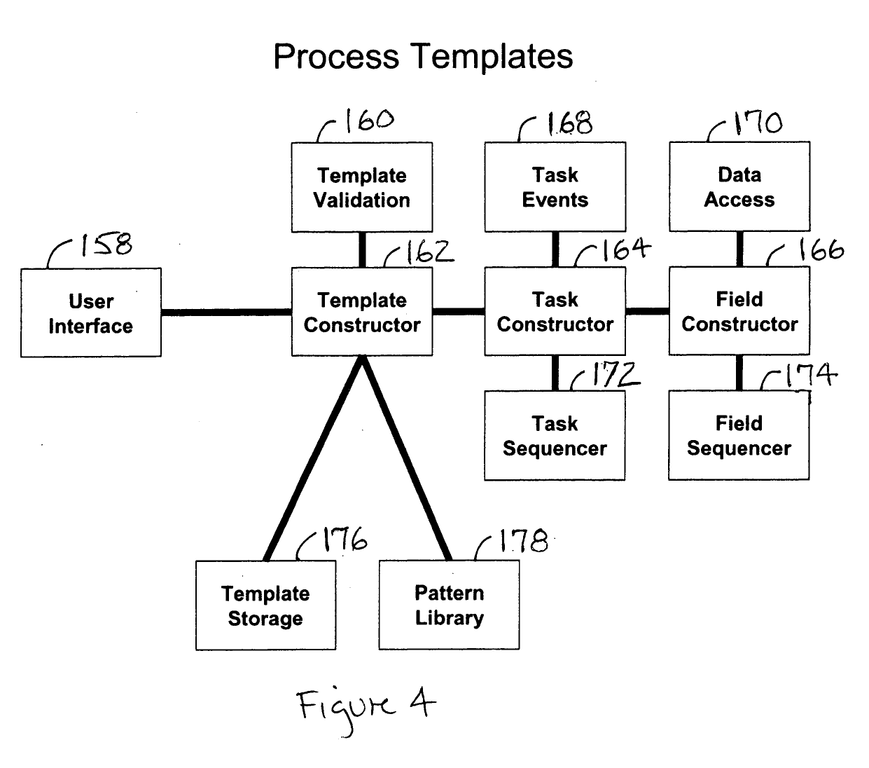

FIG. 4: Process Templates shows more detail regarding Process Templates. The components of the Process Template subsystem, in accordance with one embodiment of the invention, include:
User Interface (158)—allows the user to construct and edit Process Templates
Template Validation (160)—performs various semantic checks on the template, such as making sure branch targets are defined, ensuring there are no branches from one parallel path into another, and so on. These checks are independent of the Process Engine.
Template Constructor (162)—implements the details of constructing or editing a Process Template.
Task Constructor (164)—implements the details of constructing or editing a task within a Process Template.
Field Constructor (166)—implements the details of constructing or editing a field within a task.
Task Events (168)—handles the details of time-specific or exceptional events within a task.
Data Access (170)—provides a uniform mechanism and notation to save and retrieve data to and from internal and external data sources.
Task Sequencer (172)—performs the reordering of tasks within a Process Template.
Field Sequencer (174)—performs the reordering of fields within a task.
Template Storage (176)—saves and retrieves Process Templates from persistent storage.
Pattern Library (178)—maintains a collection of task patterns to be used when constructing a new sequence of tasks within a Process Template. These patterns represent a generally repeatable design solution to a commonly occurring problem in construction of templates, and capture best practices. The Pattern Library 178 also contains descriptive information to aid the author in pattern selection.

Task patterns simplify and enhance the construction of Process Templates. When constructing a Process Template, the user authoring the template is presented with a list of task patterns from the Pattern Library 178. The patterns can represent sequencing operations such as a managerial approval cycle or distribution of a review document among several users. Other patterns can provide a predefined solution to a problem the author is unsure how to solve. When the author selects a pattern, the pattern is incorporated into the Process Template by the Template Constructor 162. Although the author may need to supply certain details such as appropriate task names, use of a pattern can result in several tasks added to the Process Template with complicated sequencing already worked out.

Process Compiler

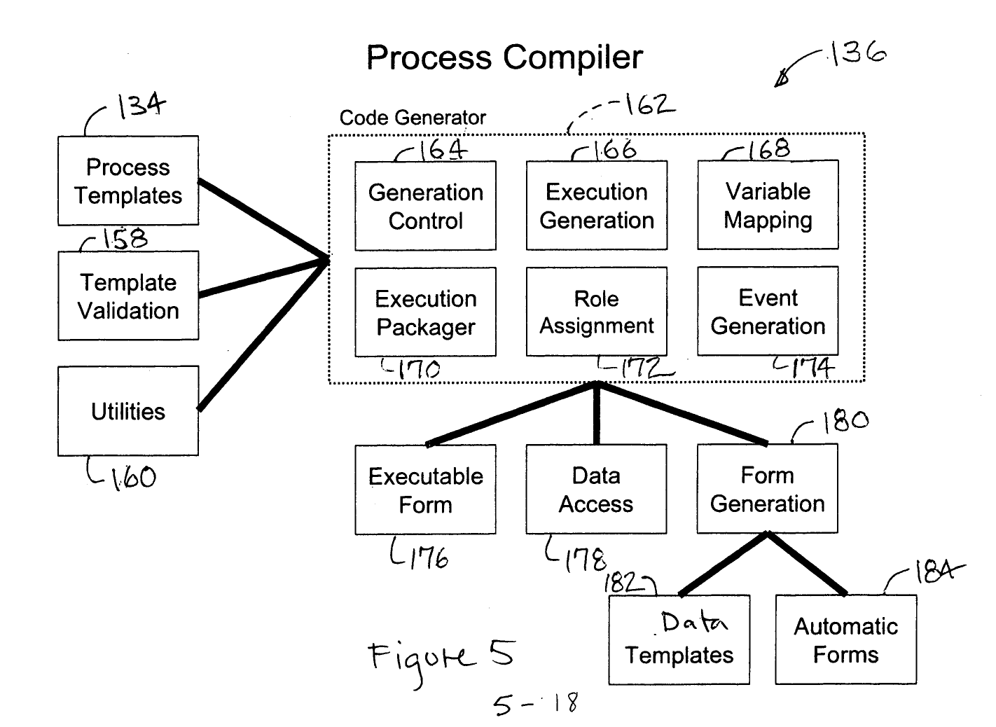

As mentioned earlier, the Process Compiler 136 is responsible for translating the user-friendly form of process templates into a form that can be executed. FIG. 5: Process Compiler shows more detail.

The Process Compiler 136 is designed to isolate the details of process execution from the rest of the system. If execution requirements change, a different Process Execution component may be substituted with minimal impact on the rest of the system. Only the Code Generator components (within the dotted line on the diagram) need to change. This represents a significant advantage of the invention.

The components of the Process Compiler 136, in accordance with one embodiment of the invention, include:
Process Templates (134)—the user-oriented internal form of process templates.
Template Validation (158)—performs additional semantic checks on the template that are specific to the Process Engine.
Utilities (160)—various support routines for external name formatting, etc.
Code Generator (162)—in broad terms generates code for execution by Process Engine 152. Code generator 144 includes:
Generation Control (164)—controls the construction of the Process Execution-specific form of the Process Template.
Execution Generation (166)—generates the sequencing and looping constructs for the template.
Variable Mapping (168)—performs the mapping from variables and fields of the Process Template into variables provided by the Process Execution component. For instance, the Process Engine may not allow the same characters in an identifier as those allowed by the system. Similarly, the “text” data type provided by the system might be called “string” in the Process Engine.
Execution Packager (170)—constructs the Executable Form of the Process Template.
Role Assignment (172)—handles assignment of people or groups of people to variables with the executable form, including initial assignment at the start of process execution.
Event Generation (174)—maps time-sensitive events, such as time-bounded tasks, as well as user exception handling, such as task reassignment to another person, into actions that can be expressed in the language of the Process Execution component. Those of skill will appreciate that the language is Process Engine-specific. Thus, in accordance with one embodiment of the invention, the Process Engine uses the XML language, but it contemplated as being within the spirit and scope of the invention to use an alternative language with an alternative Process Engine.
   Those of skill in the art will appreciate that the forms-related blocks shown in FIG. 5 in accordance with one embodiment of the invention are parts of forms 156 of FIG. 3.
Executable Form (176)—the data structures required by the Process Execution component for storage and execution of the Process Template.
Data Access (178)—in conjunction with Variable Mapping, handles reading and writing data between Process Execution variables and internal and external data sources.
Form Generation (180)—performs the mapping between each task of the process and the form presented to the user. A form may be defined by one or more Form Templates 182 or by one or more automatically generated Automatic Forms 184 based on the task and process variables. For automatically generated forms, the system looks at the fields in the task and automatically generates HTML code (for example) for each field that is to be presented to the user from the task. For user-specific forms, the user creates a form in a word processor, spreadsheet, etc. (for example) and defines an association between task fields and fields in the form.

Those of skill in the art will appreciate that the invented process compiler operates somewhat conventionally but in a new context, in accordance with the present invention. An author creates a Process Template by filling out a collection of tables. These tables indicate the individual steps or Tasks in the process, their roles, sequencing, parallelism, etc.

(Those of skill in the art will appreciate that it is the province of the author to define parallel/concurrent Tasks, i.e. Tasks capable of parallel or concurrent execution. For example, if tasks A, B, C are assigned different roles, the Tasks might be performed in parallel, e.g. prepare gravy, cook meet, make salad. Alternatively if Tasks A, B, C are assigned different roles, the Tasks might alternatively be performed in sequence, e.g. obtain manager's approval, obtain VP's approval, obtain President's approval. Thus, the invented system makes no assumptions about whether Tasks assigned to different roles can be performed in parallel. Instead the author instructs the system, in accordance with one embodiment of the invention, regarding parallel Tasks, using an outline-style indentation or a two-dimensional grid layout to indicate parallelism.)

The author also fills out tables indicating the data presented to the person responsible for completing that Task, including presentation order, format, value, explanatory instructions, etc. This data corresponds to fields on a paper form. So a Process Template combines execution, data input and data output into a single embodiment.

Process compilation translates the user-friendly Process Templates into an efficient, executable format that can be interpreted and acted upon by the Process Engine. (This follows the conventional view of compilation, which as stated above is analogous to the invented process compilation.) The Process Compiler analyzes and extracts process execution information from the Process Template, and then generates a series of instructions that can be interpreted by the Process Engine to accomplish the work represented by the Process Template. In addition to the sequencing and parallelism of Tasks, the Process Compiler must generate the correct Process Engine instructions to accomplish assignment of people to Roles as well as the input and output of data, including possible automatic generation of electronic forms for data entry and display. Process compilation must take place, as will be appreciated, before process execution, and may take place in parallel with other system activities.

The invented system thus creates an association between the Process Template and the executable form used by the Process Engine. When a user of the system indicates that a new Process is to be executed by selecting a Process Template, the system requests that the Process Engine begin execution of the associated executable form. The executable form is effectively hidden from the user of the system in order to present a simpler user interface.

Process Execution

In order to perform useful work in the system, a Process Template is converted to an executable form by the Process Compiler. The executable form, along with instance data, is started as a new process by the Process Execution component. A process may be started by a user or some other agent. The Process Execution component then manages the interactions with users assigned to roles in the process by sequencing through the tasks in the order defined by the Process Template. When the last task is finished, the process is terminated, but all data, including state changes, are preserved in storage for traceability.

In brief review, Process Execution components (see FIG. 3: Processes), in accordance with one embodiment of the invention, include:
Process Engine (152)—the mechanism controlling the sequencing of tasks and events within the process.
Forms (156)—used to structure and format the display and input of data between the user and each task. Forms may be defined by Form Templates or may be automatically generated by the system using the data within the task.
User Interaction (154)—supports interaction between the user and the tasks of the process using Forms. This interaction may take place through any number of devices, such as a web browser, cell phone, personal information manager (PIM), personal digital assistant (PDA), or other devices.
Data Access (140)—provides a uniform mechanism for accessing data, whether they are stored in an internal or external data store.
Notification (146)—handles notification to users about various events, such as when a task is assigned to a user. Notification may take place through any number of mechanisms, such as email, phone, instant messaging, or other devices.
Scheduler (148)—deals with time-dependent operations during process execution, such as tasks that must be completed within a certain time limit or tasks that have a delayed start time.
Security (150)—controls access to data and other process information during execution.
   Processes, Reports, and Forms

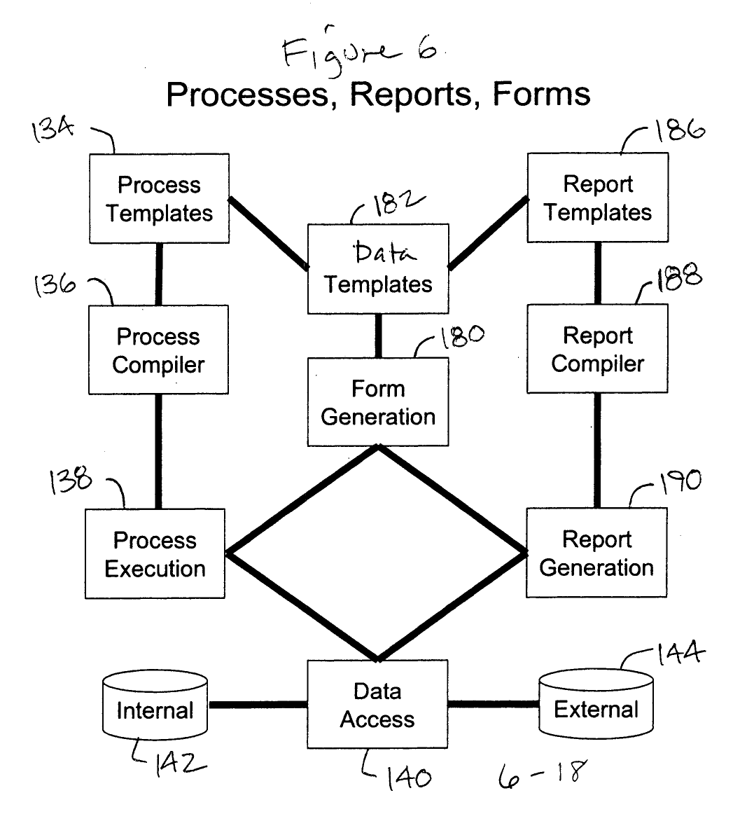

Processes, Report and Forms components (see FIG. 6: Processes, Reports, and Forms), in accordance with one embodiment of the invention, includes:
Process Templates (134)—the user-oriented internal form of process template.
Process Compiler (136)—translator of user-friendly process template form into executable form.
Form Templates (182)—templates for generating standard forms for task-oriented data.
Form Generation (180)—generates forms, whether templated or automatic, for structuring and formatting task-oriented data.
Report Templates (186)—the user-oriented internal form of report template.
Report Compiler (188)—translator of user-friendly report template form into executable form.
Process Execution (138)—interacts with the user and with the process compiler to execute sequential tasks as defined by the user in the form of a Process template.
Report Generation (190)—generates reports of data gathered by the system including history of process and task execution.
Data Access (140)—internal (system-provided) or external (user-provided) persistent data store and access control 142 and 144, respectively.

Those of skill in the art will appreciate there are parallels between process compilation and report compilation, between process templates and report templates, and form templates and form generation. Thus, the symmetries evident in FIG. 6. Moreover, those of skill in the art will appreciate there is a common data access mechanism for all three, including a mechanism for accessing legacy databases.

Data Templates and Data Access

Each piece of data (field) manipulated by a task has a name and a type (i.e., string, number, list, etc.) that specifies the set of values that the field may contain. Fields can be composed into a collection or Data Template that can be referenced as a group or piecemeal. This is analogous to defining the database schema for a traditional database. Data Templates can be defined implicitly—all fields used by tasks within a process are collected into a Data Template with the same name as the Process Template; or explicitly—a Process Template author can define a Data Template outside of a Process Template definition and give it a name. One or more Data Templates are associated with every process, explicitly or implicitly.

In addition to type, a Data Template can associate additional attributes with each component. One attribute specifies whether the data are persisted internally or externally, such as in an external database. By default, data is persisted in internal storage managed by the system. For externally stored data, the author can specify the access method, computer name, user name, password, data source name, and other information necessary to indirectly perform the external access. Security restrictions in the form of an access control list (ACL—see Security) can also be specified.

Because the Data Template captures the necessary information for the Data Access component to manipulate data, access to data can be obtained uniformly across the system, whether the data are stored internally or externally. In addition, Data Templates provide a mechanism to create user-defined persistent data storage or databases that can be manipulated by Tasks within a Process. Also, since multiple access methods are accommodated, the external data may be provided by a mechanism implemented in software, firmware or hardware, or any suitable combination thereof, such as an executable program or a database.

Library

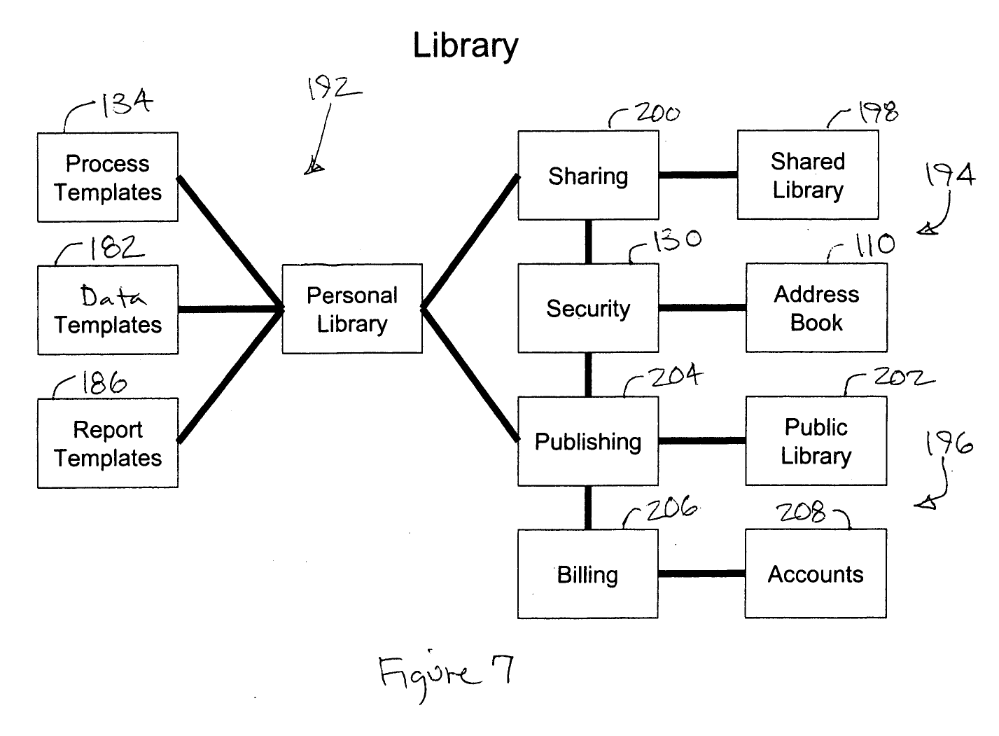

The Library component (see FIG. 7) helps the user manage structural information relating to Process Templates 134, Data Templates 182, and Report Templates 186. The various forms of templates allow an author to create structure and layout once and then to reuse that structure for repeated operations. In turn, the Library allows an author to share these structures with other users, allowing them to make use of the author's work. The author must explicitly decide to share templates; only selected system-provided templates are shared by default.

The Library has three main departments:
1. Personal Library (indicated generally at 192)—The Personal Library is the default repository of templates for each user. It forms the menu of operations the user can perform in the system. Whenever a user authors a template, it is created within the user's Personal Library. No other users can view the template unless and until the author takes explicit action to make the template visible to others.
2. Sharing Library (indicated generally at 194)—The Sharing Library allows each user to control access to their templates by other users. For each template the user authors, the user explicitly defines which users other than the author have rights to the template. The rights include visibility (who can see the template), launch (who can start a process using the template), and modify (who can make changes to the template). By default, only the author has rights to a template until one or more of such rights are granted to other users. Once an author has granted rights to others, they may add the template to their personal libraries.
3. Marketplace Library (indicated generally at 196)—The Marketplace Library provides a mechanism for general sharing of templates without targeting particular users. Any user can access the Marketplace and add the templates to his or her Personal Library, but he or she cannot redistribute the templates. When an author publishes a template to the Marketplace Library, the author adds additional descriptive information to help other users find and select the template. Also, the author decides whether to offer the template for free or to charge for its use by others.

Those of skill in the art will appreciate that a Personal Library represents the default repository of each user's templates, and thus is central to understanding the Library's structure. Any of Process Templates 134, Data Templates 182 and Report Templates 186 form part of the Personal Library part of the Library structure. The other equally important part of the Library structure provides security in access to others by way of a user's Address Book 110, the ability to share Personal Library resources, e.g., templates or processes, with others in a Shared Library 198 via sharing block 200 and the ability to publish Personal Library resources, e.g. templates or processes, with others in a Public Library 202 via publishing block 204. Finally, billing and accounting components 206 and 208 render the marketing of Personal Library resources with the public Marketplace a billable event of potentially economic, e.g. incoming producing, consequence.

Those of skill also will appreciate the distinction between modifying an original template, for example, and modifying a copy thereof. Thus, common copy v. link controls are provided so that an original template residing in a Personal Library even if published to the Marketplace and modified for alternative use by another member of the public, nevertheless maintains its original integrity within the Personal Library of its original author.

Security

For purposes of this section, the term data is used in a generic sense, and refers to internal and external data (e.g., databases) defined by Data Templates, Process Templates, Form Templates, Report Templates, etc.
Data are generally persistent. The user does not need to do anything to make sure data are saved.
Sharing is always explicit. Data are not shared between users unless a user takes explicit action to enable sharing.
Sharing can be tightly controlled. An ACL is used to control access to each resource such as templates.
Access to data is fire-walled to prevent accidental sharing and increase security.

A Process has access only to information defined and used by the process, plus organizational structure. Address Book 110 data cannot be accessed from a running Process.

An ACL that is implemented in accordance with one embodiment of the invention as a part of security block 130 and/or data access block 140 is associated with a collection of data. The ACL has a list of access rights for the associated data, and for each access right a list of users that are granted that access right. For instance a Process Template ACL includes execution, inspection, and modification access rights, while Data Templates specify read, write, creation, and deletion access rights. The presence of a user in the list of users associated with access right grants that user the access right; however, specific users may also be excluded. The Address Book 110 is consulted for expansion of the ACL into a list of actual system users.

Lists

Lists define a collection of related data. A list may contain other lists. In accordance with one embodiment of the invention, the top-level lists are:
AddressBook: the collection of entries in the user's address book. This list is only available for reporting purposes and is not available to running Processes. Values from the Address Book 110 cannot be assigned to any other variables, nor can they be modified except by the user who owns the account they are associated with.
Processes: the collection of all current and previously executed processes for the user.
Organization: the collection of organizations associated with the user.
Data: the collection of arbitrary data defined by the user. The hierarchy of the data, if any, is completely up to the user.
   List Selection

A member of a list may be selected by appending a selection expression to the name of the list. For instance, AddressBook(“John Doe”) selects the User, if any, from the AddressBook whose name is “John Doe”.

Selection expressions may take the following forms:
List(“string”)—“string” is used to select a matching member of the list. For instance, Processes(“Document Review”) selects the process whose name is “Document Review”.
List(number)—number selects a particular member of a list, where number must be at least one. For instance, if the list Workgroup has the members “joe@x.com; julia@y.com;fred@y.com”, then Workgroup(2) selects “julia@y.com”.
List(name)—name is the name of a User, or the name of a Role that has been assigned a User.
List(first)—the special name first selects the first member of the list. For instance, if the list Workgroup has the members “joe@x.com; fred@y.com”, then Workgroup(first) selects “joe@x.com”.
List(last)—the special name last selects the last member of the list. For instance, if the list Workgroup has the members “joe@x.com; fred@y.com”, then Workgroup(last) selects “fred@y.com”.
List(a:b)—a and b are numbers that represent an initial member and final member, respectively, of the list. For instance, WorkGroup(4:last) selects the fourth through last members of the list (if they exist).
List(<where-expression>)—indicated by the keyword where, selects a member by comparing member attributes to specific values (for example, Addressbook(where Name=“Bob”)

A selection expression results in a list of zero or more members. If a selection expression matches more than one member of a list, the first found is used. If a selection expression fails, for instance, by trying to select the fifth member of a list containing three elements, the returned list has zero elements (i.e., it is empty). A list of exactly one member is treated the same as the type of the first member; i.e., Workgroup and Workgroup(first) will be treated identically.

User Interface

The core functionality of the system provides structured collaboration between the system users through execution of processes and sharing of process-related information. Although the users may interact with the system through different interfaces such as cell phones, interactive voice response, etc., the preferred embodiment is a web portal.

A web portal is a method of structuring a website to provide a single point of authentication and authorization for multiple services, standardized look and feel of the user interface, the ability to personalize the selection and layout of services on an individual or group basis, membership management, internationalization, and the administration of such services.

Using the web portal as a base or container for common services, portlets provide access to specific services. The system components such as Library and Address Book are supplied as portlets. Additional portlets enhance collaboration through electronic mail (e-mail), news, instant messaging, threaded discussion forums, or shared calendar services. Other portlets provide content and document management services, allowing version control, traceability, approval cycle, scheduled publishing, indexing, and search services. Using portlets as building blocks within the web portal, system users can combine portlets into new logical groups and make use of new services as they appear.

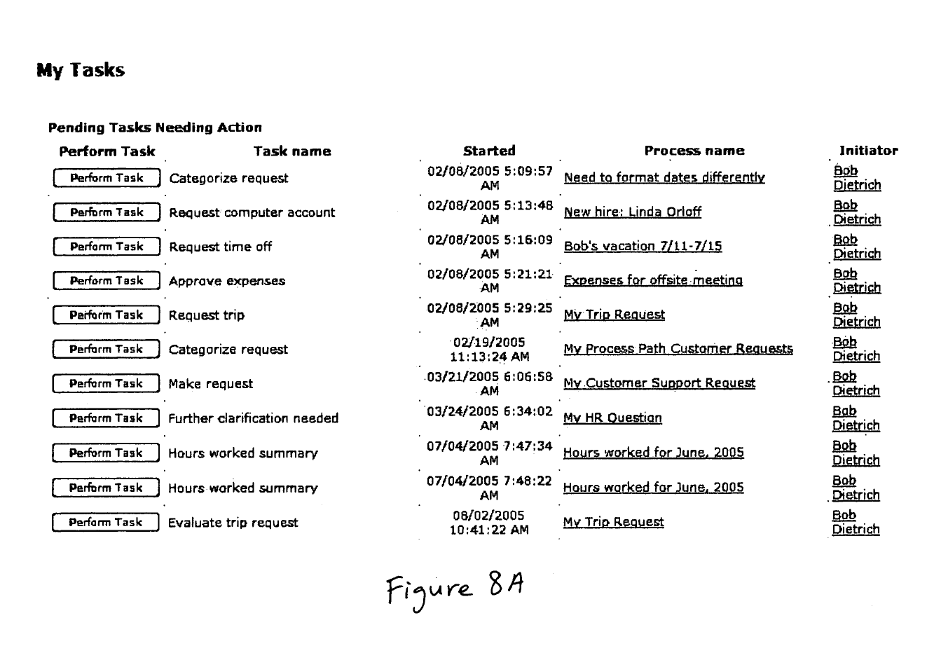

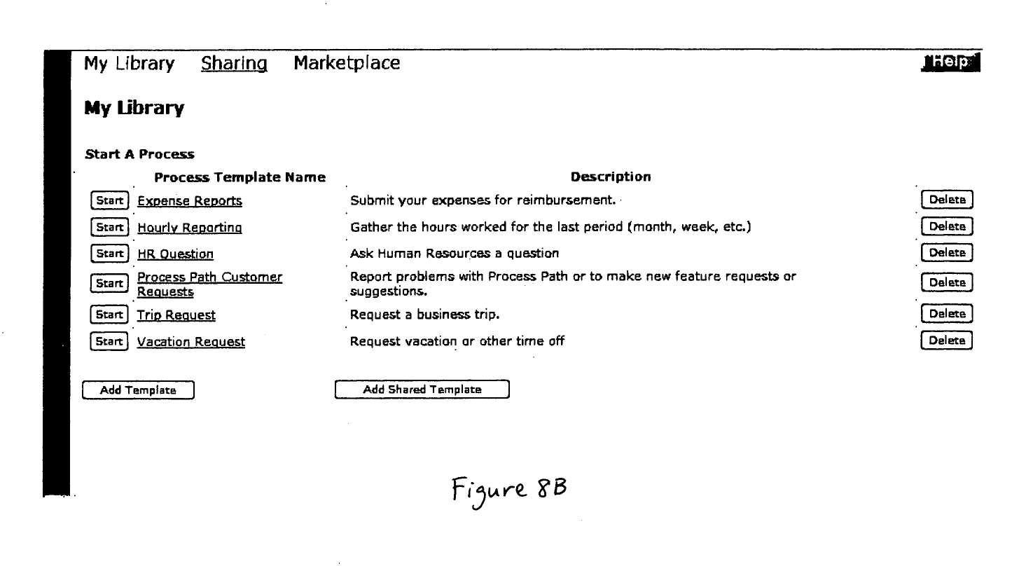

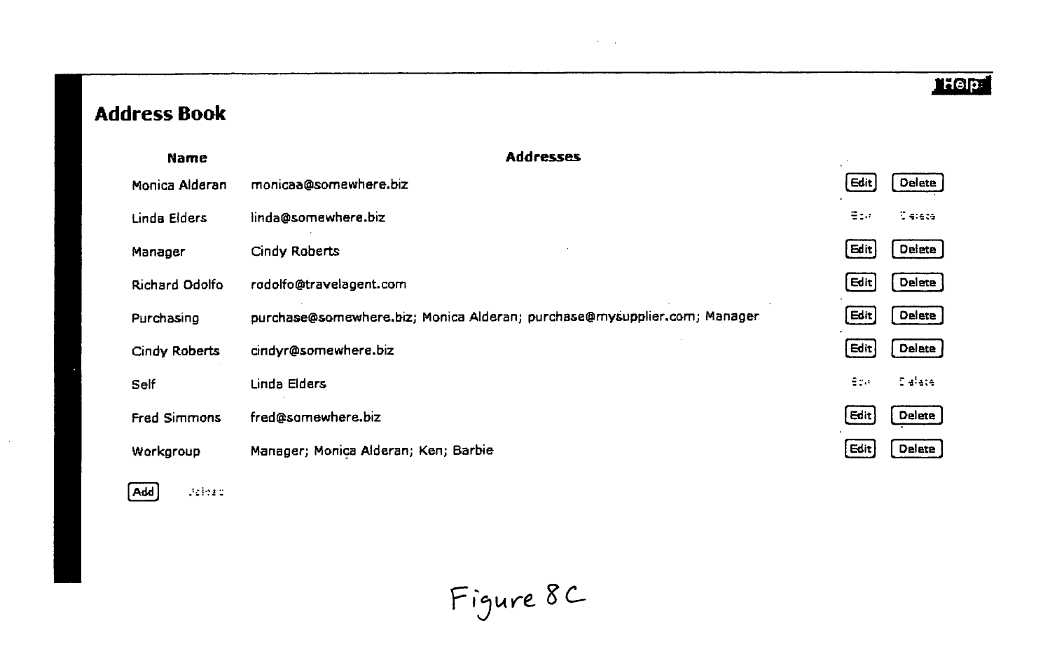

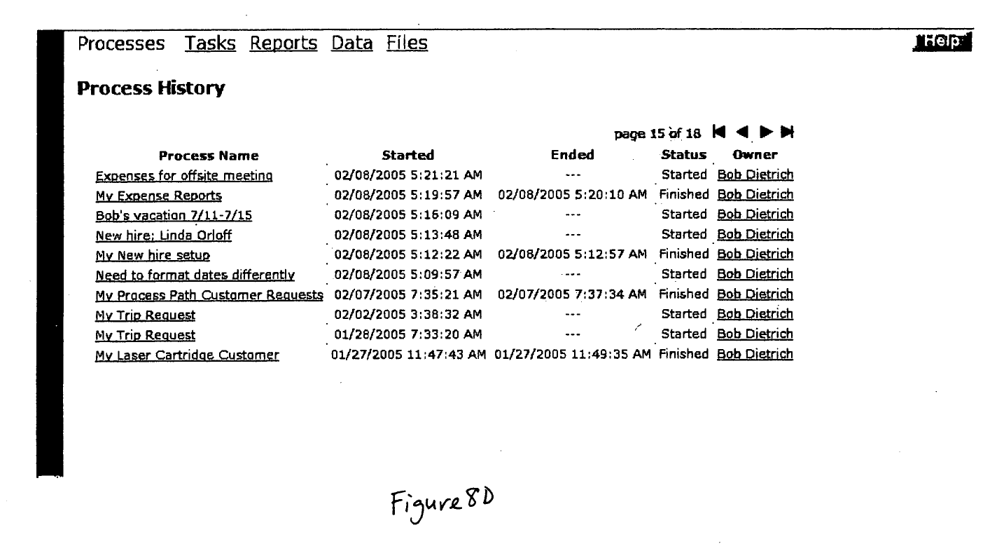

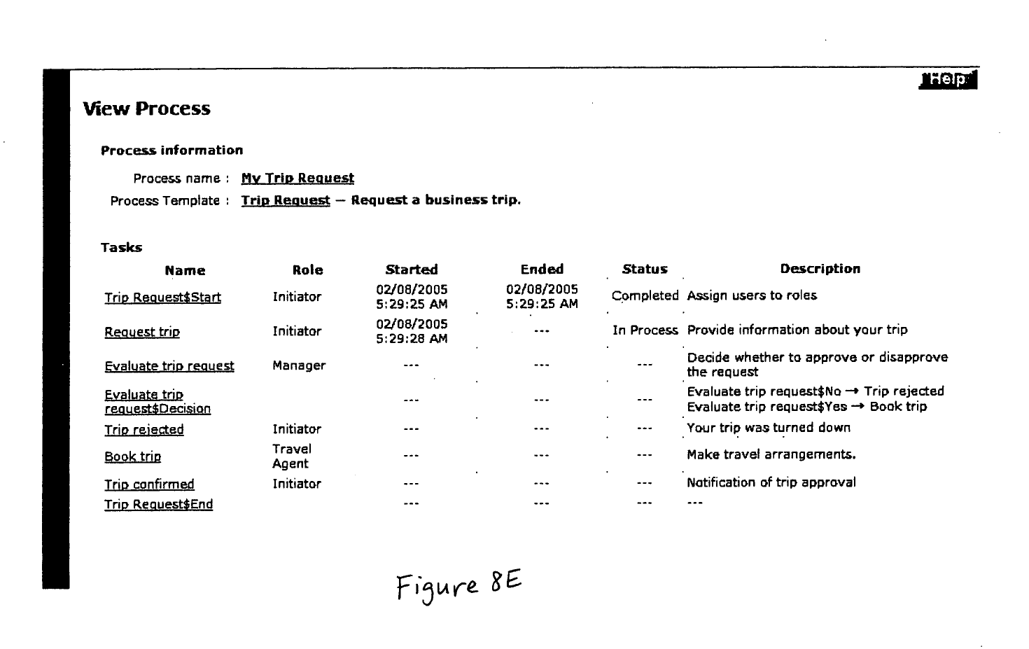

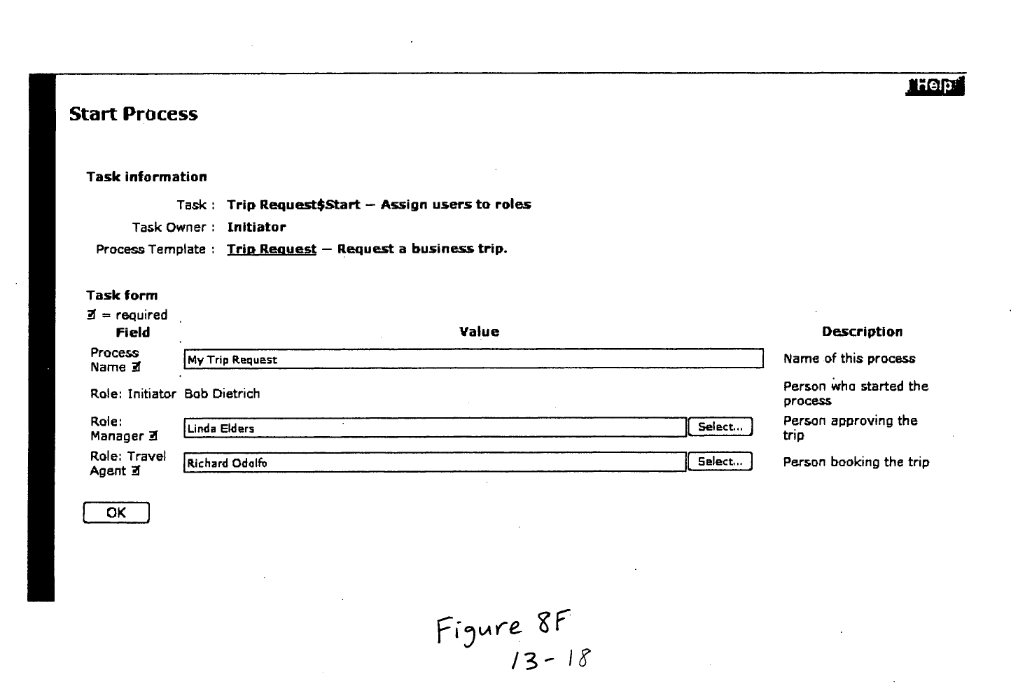

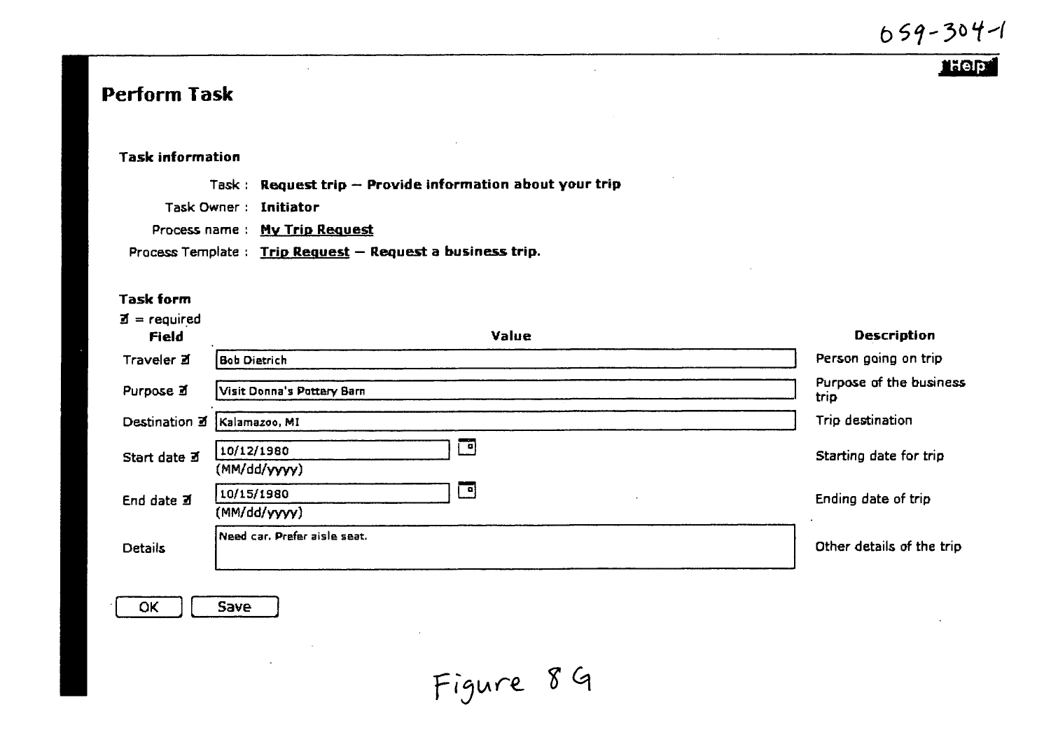

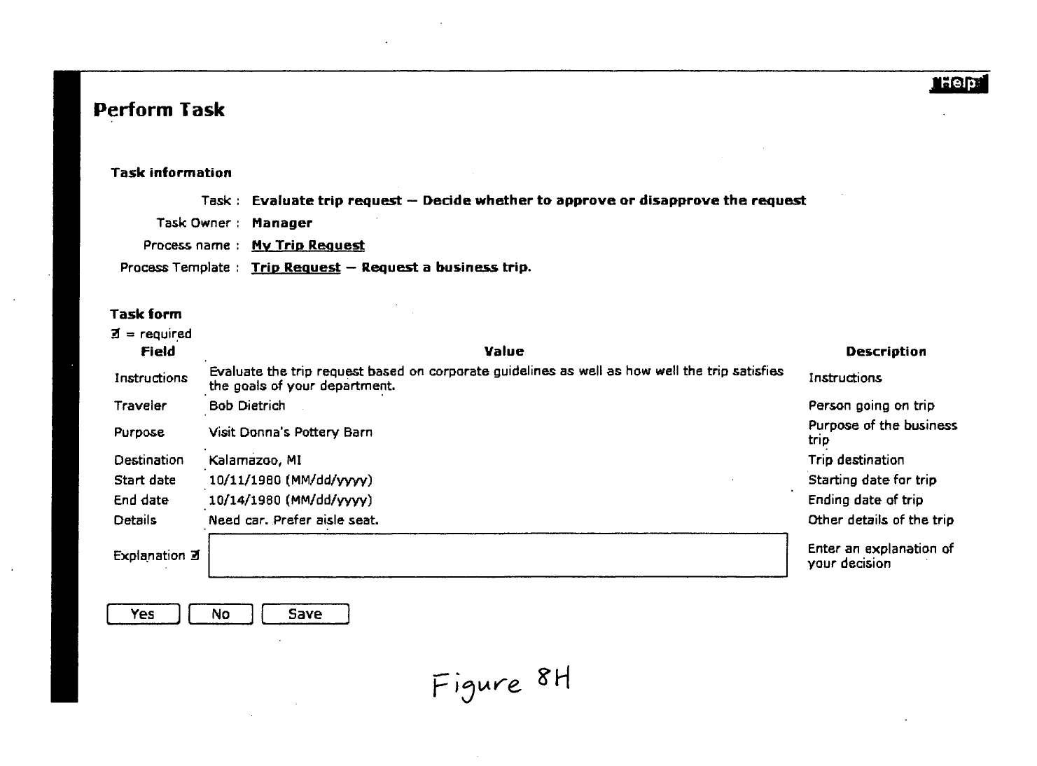

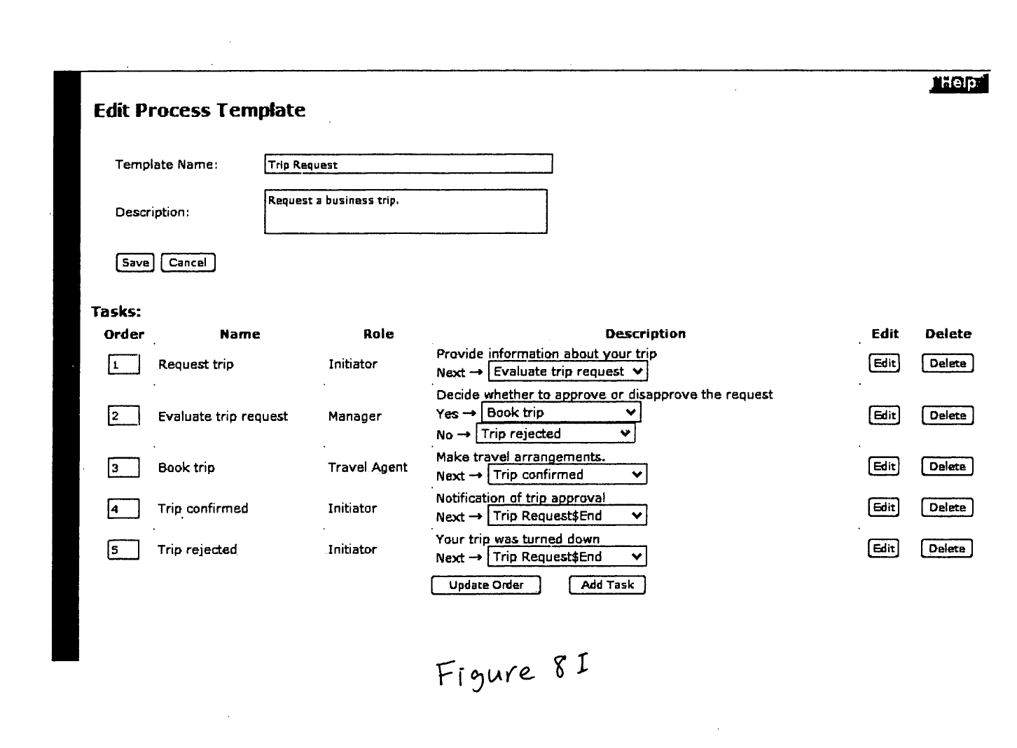

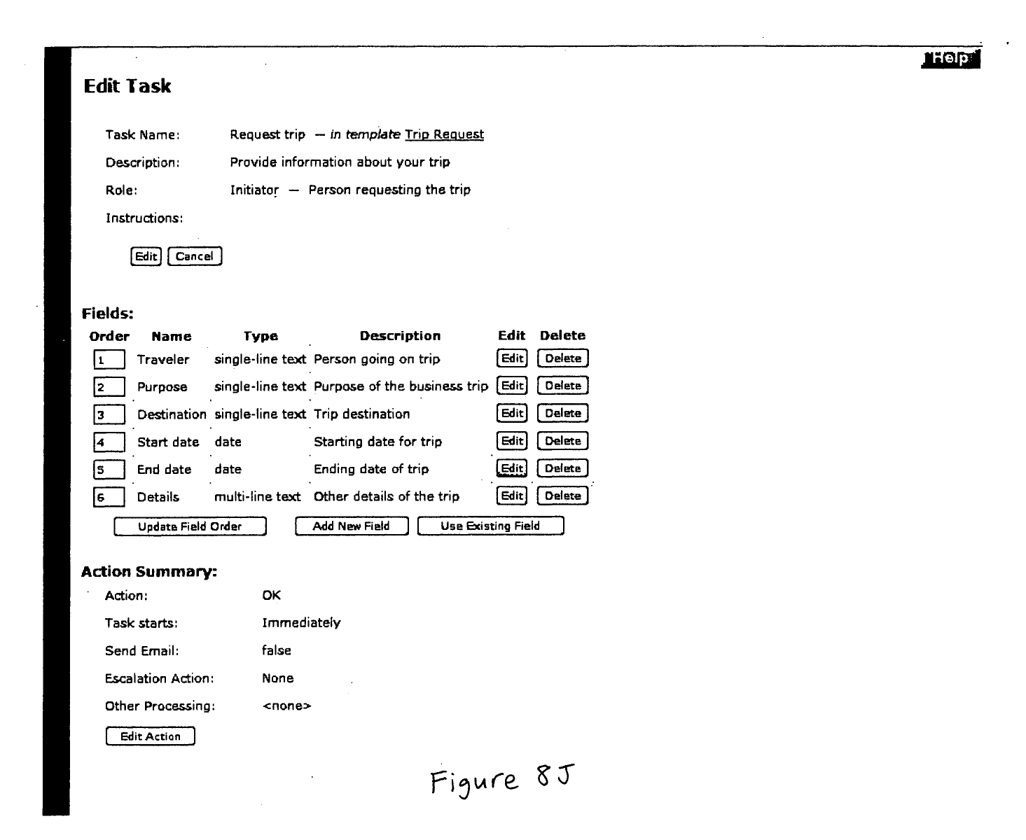

FIGS. 8A-8J schematically illustrate the user interface and interoperability of the user and the invented Process Path™ software by way of a series of diagrams representing system screen grabs. Generally, it will be appreciated that the Process Path™ windows all include a tool bar, in accordance with one embodiment of the invention, featuring My Tasks, Library, Addresses, History, Account and Maintenance tools, as well as Logoff and Help buttons. It will also be appreciated that the Process Path™ website itself includes a tool bar, in accordance with one embodiment of the invention, featuring Home, Services, About Us, Join and Help tools. Such tools may be accessed very simply by pointing and clicking with a cursor control device such as a mouse. It will be understood that the user interface operates interactively with a user in accordance with the teachings herein to invoke the software functionality described above. Those of skill in the art will appreciate that the user interface and available screens and buttons may be modified to any alternative form that is suitable to adaptation of the invention, all within the spirit and scope of the invention.

FIG. 8A will be understood to list My Tasks requiring action and to tabulate other pertinent data such as start date/time, process name and initiator. A Perform Task button is provided, in accordance with one embodiment of the invention.

FIG. 8B will be understood to list My Library processes by process name and description. Start, Edit and Delete buttons are provided along with an Add Template button, in accordance with one embodiment of the invention.

FIG. 8C will be understood to list Address Book by addressee name. Edit and Delete buttons are provided, in accordance with one embodiment of the invention, along with an Add Address book entry button.

FIG. 8D will be understood to list a Process History summary of My Most Recent Processes by name in reverse-chronological order and to tabulate the task description, start/end dates and status as well as the process start/end dates, status and owner, in accordance with one embodiment of the invention.

FIG. 8E will be understood to illustrate a View Process window in which a process named Process Information is tabulated by task, role, start/end dates, status and description, in accordance with one embodiment of the invention.

FIG. 8F will be understood to illustrate a Start Process window in which a particular task named Trip Request$Start is tabulated by field, value, required and description, in accordance with one embodiment of the invention. Select buttons and an Okay button are provided, in accordance with one embodiment of the invention, along with a useful field indicating the required nature of the information.

FIGS. 8G and 8H will be understood to illustrate a Perform Task window in which a particular task named Request trip is tabulated also by field, value, required and description. By comparing and contrasting FIGS. 8G and 8H, those of skill in the art will appreciate the free form nature of the tasks that can be defined by a process using the invented Process Path™ software.

FIG. 8I will be understood to illustrate an Edit Process Template window in which ordered tasks defined by a Template named Trip Request may be Edited or Deleted as needed. Those of skill in the art thus will appreciate how flexibly and easily templated processes as defined by their individual tasks can be modified and refined even after the process is defined. Save and Cancel buttons also are provided, in accordance with one embodiment of the invention.

Finally, FIG. 8J will be understood to illustrate an Edit Task window in which ordered steps within a task named Request trip (a single task within the previously illustrated Trip Request process template) may be Edited or Deleted as needed. Edit and Cancel buttons also are provided, in accordance with one embodiment of the invention.

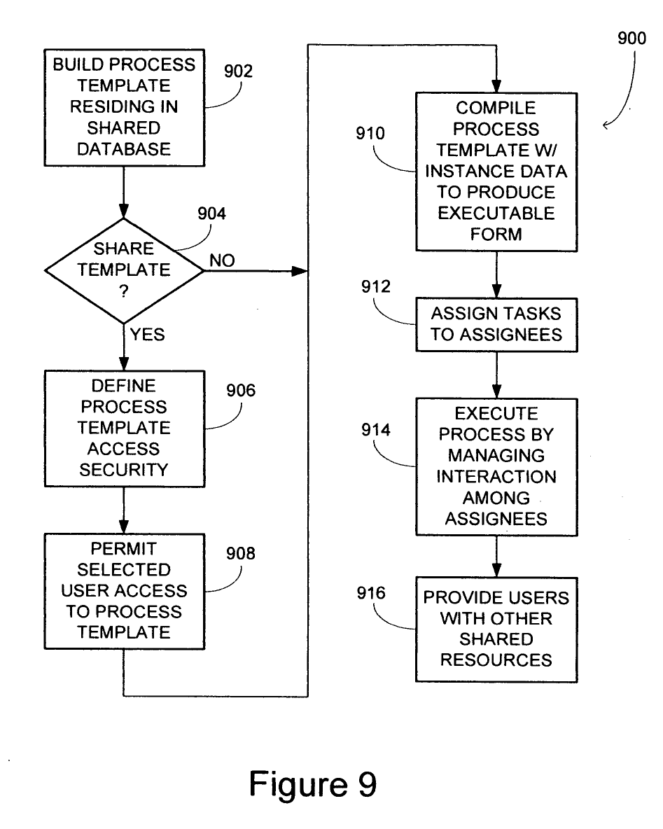

FIG. 9 is a flowchart that very simply illustrates at 900 the invented method of defining, assigning, executing and/or monitoring process and/or tasks in process management applications. In accordance with one embodiment of the invention, the method includes a) at 902 building a process template that defines a process including one or more tasks, the process template residing in a shared database; b) at 904 determining whether sharing of this process template is desired and if not, then skipping over blocks 906 and 908 and if so; then c) at 906 defining access security criteria associated with the process template; d) at 908 permitting selected users access to the process template in accordance with the defined access security criteria; and whether sharing this process template or not e) at 910 compiling the process template with instance data provided by a process initiator, e.g. author, to produce an executable process form; f) at 912 assigning the one or more tasks to one or more assignees; g) at 914 executing the process by managing interaction among the one or more task assignees and storing process trace data in the shared database; and h) at 916 optionally providing users with shared resources other than process templates, the other resources including one or more of shared databased forms, data structures and reports.

### METHOD OF USING THE INVENTION

Those of skill in the art will appreciate how straightforwardly the invention may be put to various uses, based upon the detailed description and illustrations above. As but one example, below is a script of the steps in creating a process template from scratch (a morning routine).

Note that, unlike other systems, the process template author is not required to learn flowcharting or programming, nor does the author start with a blank sheet of paper. Instead, in accordance with one embodiment of the invention, the author is guided through forms to fill out a tabular representation of the tasks and fields of the process template. The tabular representation also allows easy change and maintenance of the process template.

These advancements, along with the use of patterns representing commonly required operations, significantly broaden the ability of non-technical business users to create automated process, as illustrated by the following example:
1. Go to “Library” (refer briefly to FIG. 8B) and click on “Add Template”.
2. Fill in the name and description of the process template and then click “Save”:
   a. Enter “Morning Routine” for name.
   b. Enter “John Doe's morning routine” for description
   c. Click “Save” (next screen will be “Add Task”)
3. Create each individual step in the template. This could be done other ways, but all the tasks will be created first and then will be filled in later.
   a. Enter “Exercise” for Task Name and “Get some minimal exercise” for Description. Select “Initiator” from the “Select role . . . ” dropdown. Click “Save and Add” to save this task and add another.
   b. Enter “Check email” for Task Name and “See what's developed overnight” for Description. Select “Initiator” from the “Select role . . . ” dropdown. Click “Save and Add” to save this task and add another.
   c. Enter “Fix breakfast” for Task Name and “Fix breakfast without burning myself” for Description. Select “Initiator” from the “Select role . . . ” dropdown. Click “Save and Add” to save this task and add another.
   d. Enter “Kiss John Doe” for Task Name and “Give morning kiss to John Doe” for Description. Click the “Create” button to create a new role. Enter “Wife” for the Role Name and “Long suffering spouse” for Role Description. Click Save to save this role. Click “Save and Add” to save this task and add another.
   e. Etc.
   f. Either click “Save” instead of “Save and Add” on the last task, or click “Cancel” on a blank “Add Task” screen.
4. At this point the user is at the “Edit process template” screen, similar to FIG. 8I. One can change the template name or description, edit or delete tasks, change task ordering, or add another task. If the user has fields to add to a task, he or she clicks on “Edit” for the appropriate task and then on “Add Field”.

Briefly summarizing some of the features and advantages of the invention, it will be appreciated that process templates are arranged as tables defining an ordered series of tasks required or suggested to complete a user-defined process and to save the process to a memory device for later invocation and use by the author or another. The templates preferably are constructed via standard patterns, thus rendering their creation consistent and straightforward. Uniform data access notation is provided that makes data access for processes or reports simple, repeatable and quickly mastered. By providing for process compilation prior to execution, the Process Path™ software architecture is flexible in that different Process Engines can comprehend the compiled data without regard to the internal data structures that are converted by the compiler. Finally, task role assignments are greatly simplified by use of the process user's own address book to turn addressees into assignees, e.g. via e-mail.

Finally, those of skill in the art will appreciate that the invented system and method described and illustrated herein may be implemented in software, firmware or hardware, or any suitable combination thereof. Preferably, the system and method are implemented in a combination of the three, for purposes of low cost and flexibility. Thus, those of skill in the art will appreciate that the system and method of the invention may be implemented by a computer or microprocessor process in which instructions are executed, the instructions being stored for execution on a computer-readable medium and being executed by any suitable instruction processor.

Accordingly, one embodiment of the invention in terms of the invented system and method has been described in detail above. The detailed description is intended to illustrate the invention and not to limit it. Thus, alternative embodiments are contemplated, and all such alternative embodiments are deemed to be within the spirit and scope of the invention defined by the claims below.

I claim:

1. A method for defining, assigning, executing and/or monitoring processes and/or tasks in process management applications, the method comprising:
building a process template that defines a process including one or more tasks, the process template residing in a shared database;
assigning the one or more tasks to one or more assignees;
defining access security criteria associated with the process template; and
permitting selected users access to the process template in accordance with the defined access security criteria.

2. The method of claim 1, wherein the access security defining includes granting or denying one or more of visibility, launch and modify process permissions.

3. The method of claim 2 which further comprises:
compiling the process template with instance data provided by a process initiator to produce an executable process form.

4. The method of claim 3 which further comprises:
executing the process by managing interaction among the one or more task assignees and storing process trace data in the shared database.

5. The method of claim 4 which further comprises:
providing users with shared resources other than process templates, the other resources including one or more of shared databased data structures, forms and reports.

6. The method of claim 5, wherein the steps are facilitated by software residing for execution in a central location remote from the users but providing access thereto.

7. The method of claim 6, wherein the access is provided via a web portal and one or more defined portlets featured in a graphical user interface available to subscribing users.

8. The method of claim 7, wherein the shared resources including at least the process templates are copy-able, editable and launchable as user-specific instantiations by the users thereof.

9. The method of claim 8, wherein a growing store of shared resources is departmentalized at the central location into departments representing at least personal to author who performed the building step, sharable to targeted users by use category including the visibility, launch and modify process permissions and sharable with all subscribing users of the process management application.

10. A process-sharing system comprising:
persistent data stored in a memory of the system, the data including a process template defining the structure and sequencing of one or more tasks to be performed repeatedly by one or more users or by one or more automated processes;
an address book mechanism configured to be used by an initiator of the process template to assign a user by name or title or group to a given one or more tasks of the process template; and
a process template compiler mechanism configured to translate a given process template from a structure facilitating human interaction to a structure facilitating computer process execution.

11. The system of claim 10 which further comprises:
a table-driven process template creation mechanism including plural tabulated prompts for guiding an author through a defined set of template-creation steps.

12. The system of claim 11 which further comprises:
a pattern-assisted process template creation mechanism including a task pattern library of predefined task sequences, the library including key textual or graphic keys recognizable by an author for assisting the author in selecting a corresponding task pattern for use in template creation.

13. The system of claim 10 which further comprises:
a data access mechanism enabling uniform access to data whether internal or external, the access mechanism including a data template that defines one or more data attributes including location.

14. The system of claim 10 which further comprises:
a process template instantiation mechanism operatively coupled with the process template and with the compiler mechanism, the instantiation mechanism configured to instantiate and execute a process derived from an associated process template and associated persistent data.

15. The system of claim 10 which further comprises:
a computer process execution engine for executing the translated-to structure of the process template instantiation compiler mechanism.

16. The system of claim 10, wherein the process template is shared across the system by plural users of the system, and wherein variable data specific to a particular instantiation defined by a particular user of the process-sharing system is supplied by the system to the process template instantiation compiler for translation thereof into a form executable by a process engine.

17. The system of claim 1 0 which further comprises:
a delayed task mechanism for automatically determining when within a defined time period to complete an assigned task an assignee of the task fails to complete the assigned task.

18. The system of claim 17 which further comprises:
an automatic escalation mechanism for automatically escalating the delayed task via an electronic reminder to the user who fails within a defined time period to complete the assigned task.

19. The system of claim 10 which further comprises:
a data sharing mechanism operatively coupled with the address book for selectively sharing the persistent data including the process template among the plural users of the system, wherein the author of the persistent data determines which one or more of the users listed in the address book defines an access control list granting or denying access by the plural users of the system to the persistent data.

20. A process compiler for use with a process management system comprising:
a code generator mechanism for inputting a process template and a separate corresponding data instantiation including one or more role assignments and one or more time-sensitive events,
the code generator mechanism being coupled with a process template configured to outline one or more tasks associated therewith, and
the code generator mechanism being coupled with a process engine configured to execute the code generated by the code generation mechanism,
the code generator mechanism generating code executable by the process engine.

21. The compiler of claim 20 which further comprises:
a form generator mechanism for mapping each of the one or more tasks associated with the process template into a form visually presentable to a user of the process management system, the mapping of each task in the case of an automatic form including automatically generating hyperlink text management language (HTML) code corresponding to each field of the task.

22. The system of claim 21 which further comprises:
a variable mapping mechanism for mapping each of the one or more variables or variable types of the process template into variables or variable types comprehended by the process engine.

23. The system of claim 22 which further comprises:
a role assignment mechanism for assigning one or more users of the process management system into variables including initial assignment variables comprehended by the process engine.
